(19) United States
(12) Patent Application Publication
(10) Pub. No.: US 2009/0094694 A1
(43) Pub. Date: Apr. 9, 2009

(54) COMMUNICATION APPARATUS

(76) Inventor: Itaru Kodaira, Kanagawa (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/243,307

(22) Filed: Oct. 1, 2008

(30) Foreign Application Priority Data
Oct. 5, 2007 (JP) 2007-262267

(51) Int. Cl. G06F 21/00; G06F 3/00

(52) U.S. Cl. 726/16; 715/700

(57) ABSTRACT

A communication apparatus is disclosed. The communication apparatus includes a destination information storing unit which stores a destination name and destination information corresponding to the destination name, an operating screen displaying unit which displays information of operations of the communication apparatus, and a destination information non-display determining unit which determines whether the destination information is not to be displayed on the operating screen. When a destination name stored in the destination information storing unit is displayed and the destination name is selected as a destination, the operating screen displaying unit displays the destination information together with the destination name on the operating screen. When the destination information non-display determining unit determines that the destination information is not to be displayed on the operating screen, the destination information non-display determining unit does not display the destination information on the operating screen.

### BACKGROUND OF THE INVENTION

1. Field of the Invention

The present invention generally relates to a communication apparatus in which destination information is suitably managed when communications are executed with a destination apparatus by displaying the destination information on an operating panel of the communication apparatus such as a MFP (multifunctional peripheral), a facsimile apparatus, and a terminal having an e-mail function.

2. Description of the Related Art

In a communication apparatus such as a facsimile apparatus and a computer, destinations have been registered in an address book beforehand, and when a document (image data) is transmitted to a destination, the destination is selected from the address book and the document is transmitted to the destination based on a telephone number (facsimile number), an e-mail address, or an IP address.

However, when a destination is selected from the address book, in one case, similar destination names, for example, “FUKUOKA 1” and “FUKUOKA 2” have been registered in the address book, and in another case, a user does not know the telephone number, the e-mail address, or the IP address of the destination; the user may transmit the document to a wrong destination.

In order to avoid the wrong transmission, a technology is disclosed. In the technology, when a destination is selected from the address book, destination information is displayed on an operating panel of the apparatus so that the user can confirm the destination information before transmitting the document. For example, in Patent Document 1, the destination and the destination information are displayed on a touch panel of the apparatus, and when the user touches the destination information, the document is transmitted to the destination. With this, the wrong transmission of the document is avoided.

[Patent Document 1] Japanese Laid-Open Patent Application No. 2000-115434

[Patent Document 2] Japanese Laid-Open Patent Application No. H11-234458

When an e-mail address or an IP address is leaked (disclosed) to a malicious parson, the e-mail address or the IP address may be used for spam e-mail or unauthorized access. Therefore, it is desired to manage the destination information so as not to open it to the public.

However, many destinations and destination information of the destinations have been registered in address books, and when the destination is displayed on the operating panel together with the destination information, the destination information may be leaked to a malicious person.

### SUMMARY OF THE INVENTION

In a preferred embodiment of the present invention, there is provided a communication apparatus which can suitably manage destination information of destinations.

Features and advantages of the present invention are set forth in the description that follows, and in part will become apparent from the description and the accompanying drawings, or may be learned by practice of the invention according to the teachings provided in the description. Features and advantages of the present invention will be realized and attained by a communication apparatus particularly pointed out in the specification in such full, clear, concise, and exact terms so as to enable a person having ordinary skill in the art to practice the invention.

To achieve one or more of these and other advantages, according to one aspect of the present invention, there is provided a communication apparatus. The communication apparatus includes a destination information storing unit which stores a destination name and destination information corresponding to the destination name, an operating screen displaying unit which displays information of operations of the communication apparatus, and a destination information non-display determining unit which determines whether the destination information is not to be displayed on the operating screen. When a destination name stored in the destination information storing unit is displayed and the destination name is selected as a destination, the operating screen displaying unit displays the destination information together with the destination name on the operating screen. When the destination information non-display determining unit determines that the destination information is not to be displayed on the operating screen, the destination information non-display determining unit does not display the destination information on the operating screen.

### EFFECT OF THE INVENTION

According to an embodiment of the present invention, since a communication apparatus includes a destination information non-display determining unit which determines whether destination information is not to be displayed on an operating screen, the communication apparatus can suitably manage the destination information of the destinations.

### BRIEF DESCRIPTION OF THE DRAWINGS

Features and advantages of the present invention will become more apparent from the following detailed description when read in conjunction with the accompanying drawings, in which:

FIG. 1 is a structural diagram of a communication apparatus according to an embodiment of the present invention;

FIG. 2 is a diagram showing a functional structure of the communication apparatus according to the embodiment of the present invention;

FIG. 3 is a diagram showing an operating screen on a touch panel displayed by an operating screen displaying unit shown in FIG. 2;

FIG. 4 is a diagram showing a first flow of operating screens when a destination name is selected in communications of the communication apparatus with a destination apparatus;

FIG. 5 is a user information management table in which non-display of the destination information on the touch panel is determined for each user;

FIG. 6 is a diagram showing a second flow of the operating screens which are displayed by the operating screen displaying unit when a user operates the communication apparatus shown in FIG. 2;

FIG. 7 is an address book table in which non-display of the destination information on the touch panel is determined for each destination name;

FIG. 8 is a diagram showing a third flow of the operating screens which are displayed by the operating screen displaying unit when a user operates the communication apparatus shown in FIG. 2;

FIG. 9 is a diagram showing a communication log in the communication apparatus according the embodiment of the present invention;

FIG. 10 is an information management table in which non-display of the destination information on the touch panel is determined for each communication type;

FIG. 11 is a diagram showing a fourth flow of the operating screens which are displayed by the operating screen displaying unit when a user operates the communication apparatus shown in FIG. 2;

FIG. 12 is an address book table in which non-display of the destination information on the touch panel is determined by combining a user name with a destination name;

FIG. 13 is a diagram showing a fifth flow of the operating screens which are displayed by the operating screen displaying unit when a user operates the communication apparatus shown in FIG. 2;

FIG. 14 is a diagram showing a sixth flow of the operating screens which are displayed by the operating screen displaying unit when a user operates the communication apparatus shown in FIG. 2; and

FIG. 15 is a diagram showing an operating screen display log in the communication apparatus according the embodiment of the present invention.

### DESCRIPTION OF THE PREFERRED EMBODIMENT

### Best Mode of Carrying Out the Invention

The best mode of carrying out the present invention is described with reference to the accompanying drawings.

In an embodiment of the present invention, as a communication apparatus, a facsimile apparatus is used. However, as the communication apparatus, an MFP or a computer can be used.

[Structure of Facsimile Apparatus]

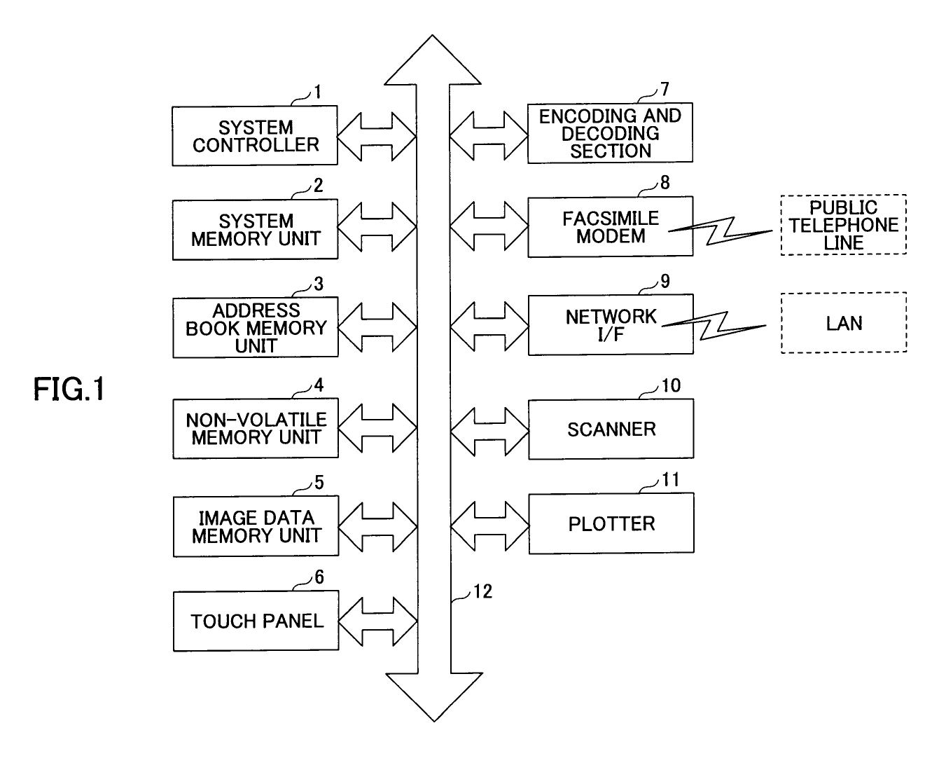

FIG. 1 is a structural diagram of a facsimile apparatus according to the embodiment of the present invention. As described above, in the embodiment of the present invention, as the communication apparatus, a facsimile apparatus is used.

As shown in FIG. 1, the facsimile apparatus includes a system controller 1, a system memory unit 2, an address book memory unit 3, a non-volatile memory unit 4, an image data memory unit 5, a touch panel 6, an encoding and decoding section 7, a facsimile modem 8, a network I/F (interface) 9, a scanner 10, a plotter 11, and a bus 12. The system controller 1 includes a CPU (central processing unit), and the system memory unit 2 includes a ROM (read only memory) and a RAM (random access memory).

The system controller 1 controls operations of elements in the facsimile apparatus by executing a program stored in the ROM while using the RAM as a working memory unit.

In the system memory unit 2, the ROM stores programs to be executed and data to be processed by the system controller 1, and the RAM temporarily stores data and a program to be executed by the system controller 1 by being loaded from the ROM during the operations of the system controller 1.

The address book memory unit 3 stores destination names and destination information of the destination names. The destination names and the destination information have been registered beforehand in the address book memory unit 3. The destination information is, for example, a telephone number (facsimile number), an e-mail address, and an IP address. When a document is transmitted to a destination, a destination name is selected from the address book memory unit 3, and the document is transmitted to the destination based on the destination information of the destination name. The address book memory unit 3 can be a part of the system memory unit 2 or the non-volatile memory unit 4.

Since information (data) stored in the non-volatile memory unit 4 is not deleted even if the power of the facsimile apparatus is turned off, the non-volatile memory unit 4 stores data and information to be permanently stored. That is, the non-volatile memory unit 4 stores information such as user management information, setting information in the apparatus, communication history information, and operated log information.

The image data memory unit 5 temporarily stores image data when image data read by the scanner 10 are transmitted to a destination via a public telephone line or a LAN (local area network) and when image data received via the public telephone line or the LAN are output from the plotter 11.

The touch panel 6 displays information such as operational guidance of the facsimile apparatus and information to be input on the touch panel 6, and receives operations input by a user when the user touches the touch panel 6.

The encoding and decoding section 7 applies an encoding compression process to image data to be transmitted by a facsimile function and applies a decoding process to encoded compressed image data received by the facsimile function. That is, for example, the encoding and decoding section 7 encodes image data to be transmitted by e-mail as MIME (multipurpose Internet mail extension) data and decodes the MIME data to produce image data.

The facsimile modem 8 connected to a public telephone line converts a digital signal from the facsimile apparatus into an analog signal, and transmits the analog signal to a destination via the public telephone line based on G3 protocol; and it receives an analog signal via the public telephone line and converts the analog signal into a digital signal for the facsimile apparatus.

The network I/F 9 receives and transmits information (data) from/to an apparatus having a communication control function connected via a network. In the embodiment of the present invention, as the network, a LAN is used as an example. The facsimile apparatus receives and transmits information (data) via the LAN based on a communication protocol such as TCP/IP (Transmission Control Protocol/Internet Protocol). In a case of IP facsimile, the network I/F 9 receives and transmits information (data) via the LAN in real time.

The scanner 10 reads image data of a document at a predetermined resolution.

The plotter 11 outputs image data at the predetermined resolution on a sheet (paper).

The bus 12 connects the system controller 1, the system memory unit 2, the address book memory unit 3, the non-volatile memory unit 4, the image data memory unit 5, the touch panel 6, the encoding and decoding section 7, the facsimile modem 8, the network I/F 9, the scanner 10, and the plotter 11 with each other, and data are transmitted and received among them via the bus 12.

In the facsimile apparatus according to the embodiment of the present invention, the destination information has been registered in the address book memory unit 3 beforehand, and facsimile communications are executed by referring to the destination information. The user inputs the destination information by touching necessary buttons on the touch panel 6.

Image data to be transmitted by the facsimile function are read by the scanner 10 and the read image data are temporarily stored in the image data memory unit 5. When the system controller 1 outputs a transmission command, the image data stored in the image data memory unit 5 are transmitted to a destination based on the destination information.

Before transmitting the image data, the encoding and decoding section 7 encodes the image data corresponding to a communication system. When the image data are transmitted via the public telephone line, the image data are transmitted via the facsimile modem 8, and when the image data are transmitted via the LAN in an IP facsimile system or an e-mail system, the image data are transmitted via the network I/F 9.

When image data are received from a destination apparatus, the facsimile modem 8 or the network I/F 9 receives the image data, and the received image data are decoded by the encoding and decoding section 7. The decoded image data are temporarily stored in the image data memory unit 5, and the image data are printed on a sheet by the plotter 11 with a print command from the system controller 1. As described above, the above communication log is stored in the non-volatile memory unit 4.

[Functional Structure of Facsimile Apparatus]

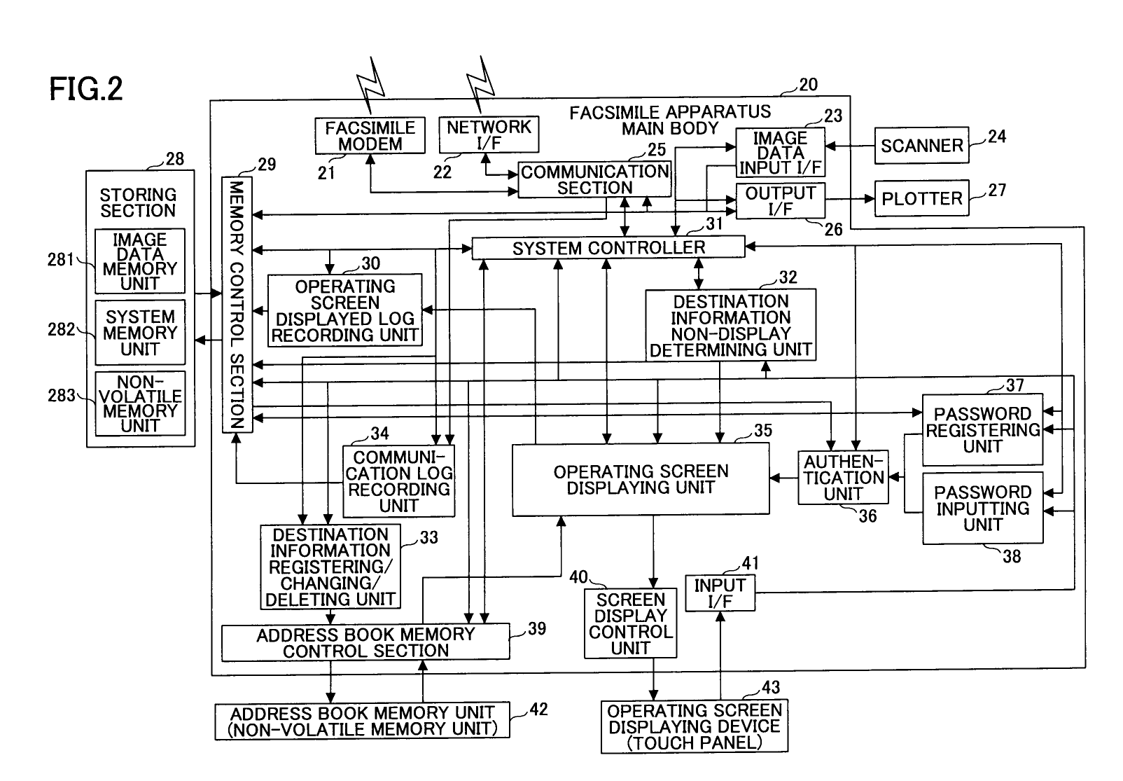

Next referring to FIG. 2, a functional structure of the facsimile apparatus according to the embodiment of the present invention is described. FIG. 2 is a diagram showing the functional structure of the facsimile apparatus according to the embodiment of the present invention. In order to describe the functional structure, in some elements of FIG. 2, the reference number is different from that shown in FIG. 1.

As shown in FIG. 2, a facsimile apparatus main body 20 includes a facsimile modem 21, a network I/F 22, an image data input I/F 23, a communication section 25, an output I/F 26, a memory control section 29, an operating screen displayed log recording unit 30, a system controller 31, a destination information non-display determining unit 32, a destination information registering/changing/deleting unit 33, a communication log recording unit 34, an operating screen displaying unit 35, an authentication unit 36, a password registering unit 37, a password inputting unit 38, an address book memory control section 39, a screen display control section 40, and an input I/F 41. In addition, the facsimile apparatus includes a scanner 24, a plotter 27, a storing section 28, an address book memory unit 42, and an operating screen displaying device (touch panel) 43.

The facsimile modem 21, the network I/F 22, the system controller 31, the scanner 24, the plotter 27, the address book memory unit 42, and the operating screen displaying device 43 correspond to the facsimile modem 8, the network I/F 9, the system controller 1, the scanner 10, the plotter 11, the address book memory unit 3, and the touch panel 6 shown in FIG. 1, respectively.

The image data input I/F 23 causes an image data memory unit 281 of the storing section 28 to store image data read by the scanner 24.

The communication section 25 has a control function of data transmission and reception to be executed via the facsimile modem 21 or the network I/F 22, and includes the encoding and decoding section 7 shown in FIG. 1.

The output I/F 26 makes the plotter 27 output image data received from a destination apparatus via the facsimile modem 21 or the network I/F 22 on a sheet (paper).

The storing section 28 includes the image data memory unit 281, a system memory unit 282, and a non-volatile memory unit 283. The image data memory unit 281, the system memory unit 282, and the non-volatile memory unit 283 correspond to the image data memory unit 5, the system memory unit 2, and the non-volatile memory unit 4 shown in FIG. 1, respectively.

The memory control section 29 controls data transmission and reception between the facsimile apparatus main body 20 and the storing section 28.

The operating screen displayed log recording unit 30 stores a displayed time and date of destination information with a displayed destination name on the touch panel 43 in the non-volatile memory unit 283 via the memory control section 29.

The system controller 31 controls all elements of the facsimile apparatus by being connected to the image data input I/F 23, the communication section 25, the output I/F 26, the memory control section 29, the operating screen displayed log recording unit 30, the destination information non-display determining unit 32, the destination information registering/changing/deleting unit 33, the communication log recording unit 34, the operating screen displaying unit 35, the authentication unit 36, the password registering unit 37, the password inputting unit 38, the address book memory control section 39, the screen display control section 40, the address book memory unit 42, and the input I/F 41.

The destination information non-display determining unit 32 determines whether some destination information that is registered in the address book memory unit 42 is not to be displayed on the touch panel 43.

The destination information registering/changing/deleting unit 33 registers destination information input on the touch panel 43 in the address book memory unit 42. In addition, the destination information registering/changing/deleting unit 33 changes or deletes some destination information which has been registered in the address book memory unit 42.

The communication log recording unit 34 stores a communication log (communicated time and date, destination information) in the non-volatile memory unit 283 via the memory control section 29 when the facsimile apparatus executes communications with a destination apparatus via the facsimile modem 21 or the network I/F 22.

The operating screen displaying unit 35 causes the touch panel 43 to display operational information of the facsimile apparatus.

The authentication unit 36 authenticates whether a password which has been registered in the non-volatile memory unit 283 via the password registering unit 37 is equal to a password input on the touch panel 43 via the password inputting unit 38.

The password registering unit 37 registers a password input on the touch panel 43 in the non-volatile memory unit 283 via the memory control section 29.

The password inputting unit 38 causes the touch panel 43 to input a password and sends the input password to the authentication unit 36.

The address book memory control section 39 controls writing destination information in the address book memory unit 42 and controls reading destination information from the address book memory unit 42.

The screen display control section 40 controls screens displayed by the operating screen displaying unit 35 on the touch panel 43.

The input I/F 41 sends information input from the touch panel 43 to the storing section 28, the system controller 31, the destination information non-display determining unit 32, the destination information registering/changing/deleting unit 33, the password registering unit 37, the password inputting unit 38, and the address book memory control section 39.

Next, operations of the facsimile apparatus are described. In a case where operations are initiated on the touch panel 43, when a user selects an operation on the touch panel 43, an operating screen is read from the system memory unit 282 via the memory control section 29. The operating screen is displayed on the touch panel 43 via the memory control section 29, the operating screen displaying unit 35, and the screen display control section 40.

When a user registers destination information in the address book memory unit 42, the user inputs the destination information with the destination name on the touch panel 43. The input destination information and the destination name are registered in the address book memory unit 42 via the input I/F 41, the destination information registering/changing/deleting unit 33, and the address book memory control section 39.

When the user changes or deletes the destination information and the destination name that are registered in the address book memory unit 42, the user inputs the change or deletion on the touch panel 43. The input change or deletion information is registered in the address book memory unit 42 via the input I/F 41, the destination information registering/changing/deleting unit 33, and the address book memory control section 39.

The registered destination information including the destination name is displayed on the touch panel 43 via the address book memory control section 39, the operating screen displaying unit 35, and the screen display control section 40. When the user desires to communicate with a destination registered in the address book memory unit 42 and selects a destination name on the touch panel 43, the destination name is sent to the address book memory control section 39 via the input I/F 41. The address book memory control section 39 reads the destination information of the destination name from the address book memory unit 42, and the read destination information is displayed on the touch panel 43 by the operating screen displaying unit 35 and the screen display control section 40. When the user confirms the destination information and inputs a facsimile transmission instruction on the touch panel 43, the facsimile transmission is executed.

When image data are transmitted to a destination, the scanner 24 reads the image data and the read image data are temporarily stored in the image data memory unit 281 via the image data input I/F 23 and the memory control section 29. When the system controller 31 outputs an instruction to transmit the image data, the image data stored in the image data memory unit 281 are sent to the communication section 25 via the memory control section 29. The communication section 25 sends the image data to the destination via the facsimile modem 21 or the network I/F 22. In the above, when the image data are transmitted via the public telephone line, the facsimile modem 21 is used, and when the image data are transmitted via the LAN, the network I/F 22 is used. At this time, the communication section 25 applies an encoding and compressing process to the image data so that the image data match a data format for facsimile transmission. When the image data are transmitted by an e-mail format, the communication section 25 applies an encoding process to the image data so that the image data are converted into MIME data for e-mail transmission.

The facsimile apparatus receives image data from a destination via the facsimile modem 21 when the image data are transmitted via the public telephone line or via the network I/F 22 when the image data are transmitted via the LAN. The received image data are temporarily stored in the image data memory unit 281 via the communication section 25 and the memory control section 29. At this time, the communication section 25 applies a decoding process to the image data so that the received image data are converted into original image data. When the image data are received in an e-mail format, the communication section 25 applies a decoding process to the received image data so that the MIME image data are converted into original image data. When the image data are output by the plotter 27, the image data are read from the image data memory unit 281, and the read image data are sent to the plotter 27 via the memory control section 29 and the output I/F 26.

When it is determined that destination information corresponding to a destination name is not displayed on the touch panel 43 so as to prevent the destination information from being leaked (disclosed), the user inputs a predetermined instruction on the touch panel 43. At this time, the destination information non-display determining section 32 stores the instruction in the non-volatile memory unit 283 via the memory control section 29.

Therefore, in a case where a destination name registered in the address book memory unit 42 is displayed on the touch panel 43 and a user selects the destination name, when it is determined that the destination information of the destination name is not to be displayed, the operating screen displaying unit 35 does not display the destination information of the destination name on the touch panel 43 based on the determination by the destination information non-display determining unit 32. With this, the destination information can be suitably managed from a viewpoint of preventing the destination information from being leaked.

The destination information non-display determining unit 32 can determine whether to not display the destination information for each user, each destination name, each communication type such as facsimile, IP facsimile, and e-mail, or a combination of a user name with a destination name. With this, the destination information can be suitably managed from the viewpoint of preventing the destination information from being leaked by using the above determination.

When the destination information is displayed on the touch panel 43 by the operating screen displaying unit 35, the communication log recording unit 34 records the destination information in a communication log. When the destination information is not displayed on the touch panel 43 by the operating screen displaying unit 35, the communication log recording unit 34 records the communication information (log) without the destination information.

Next, when a password is input on the touch panel 43, the password is sent to the authentication unit 36 via the input I/F 41 and the password inputting unit 38. A password registered in the non-volatile memory unit 283 by the password registering unit 37 is sent to the authentication unit 36 via the memory control section 29. The authentication unit 36 authenticates whether the registered password is equal to the input password. When the input password is equal to the registered password, even if it is determined that the destination information is not to be displayed on the touch panel 43 by the destination information non-display determining unit 32, the operating screen displaying unit 35 always displays the destination information with the destination name on the touch panel 43. With this, since the destination name is always displayed on the touch panel 43, wrong transmission of image data can be prevented, and in addition, since the password is suitably managed, the destination information can be further prevented from the being leaked (unauthorized disclosure).

In addition, in order to suitably manage the destination information, when the destination information is displayed on the touch panel 43 by the password authentication in spite of the determination not to display the destination information by the destination information non-display determining unit 32, the operating screen displayed log recording unit 30 records the time and date and the destination name of the destination information displayed on the touch panel 43 in the non-volatile memory unit 283 via the memory control section 29. With this, even if the destination information is improperly obtained by use of a fake password and the destination information is leaked, the time and date can be used for tracing.

[First Operations of Facsimile Apparatus]

Next, referring to the drawings, first operations of the facsimile apparatus according to the embodiment of the present invention are described.

First, when a user communicates with a destination, the user selects a destination name on an operating screen in the touch panel 43 displayed by the operating screen displaying unit 35. The operating screen displaying unit 35 displays destination information together with the destination name stored in the address book memory unit 42 on the touch panel 43. The user confirms the destination information on the operating screen, and communicates with the destination.

In addition, in order to prevent the destination information from being leaked, the facsimile apparatus can determine not to display the destination information.

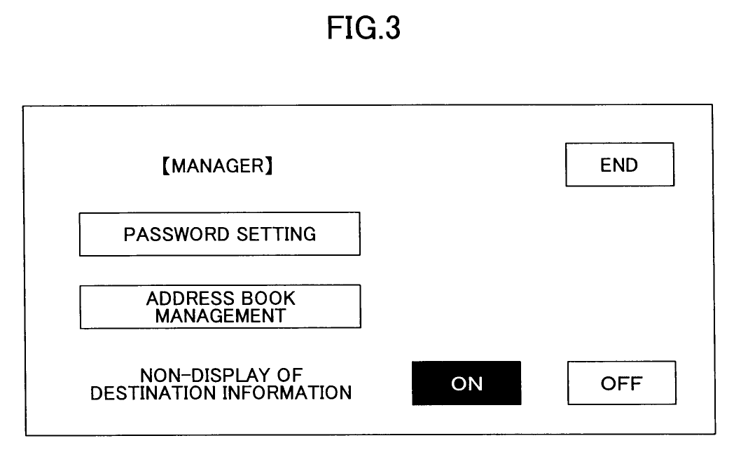

FIG. 3 is a diagram showing an operating screen on the touch panel 43 displayed by the operating screen displaying unit 35. In FIG. 3, an operating screen is displayed in which it is determined whether the destination information is to be displayed on the touch panel 43. In FIG. 3, when non-display of the destination information is determined (ON is selected in FIG. 3), the destination information non-display determining unit 32 stores an instruction for indicating that the destination information is not to be displayed in the non-volatile memory unit 283. In addition, when display of the destination information is determined (OFF is selected in FIG. 3), the destination information non-display determining unit 32 stores an instruction for indicating that the destination information is to be displayed in the non-volatile memory unit 283.

In FIG. 3, as an example, an operating screen for a manager is shown, and password setting and address book management are also shown.

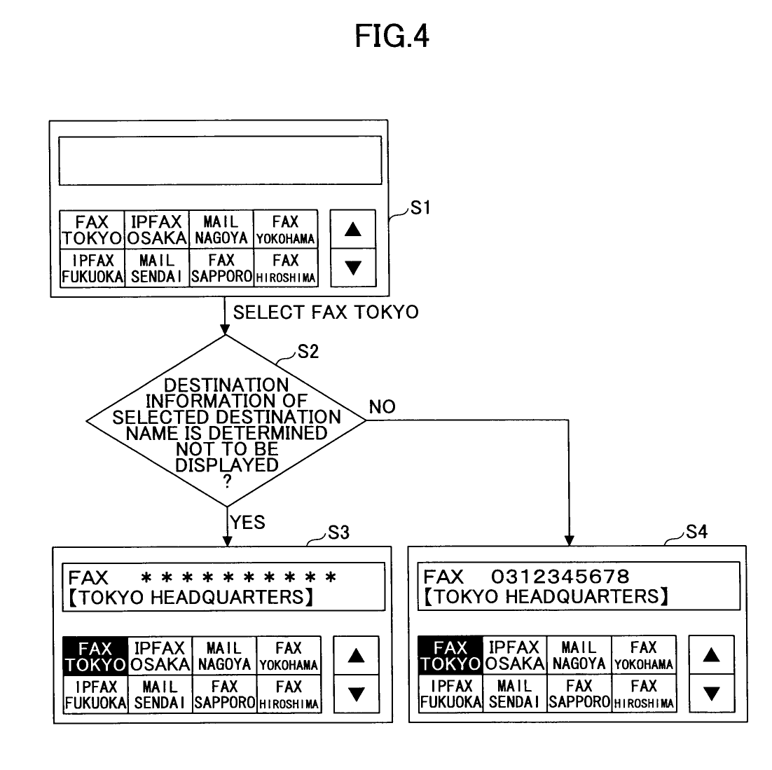

FIG. 4 is a diagram showing a first flow of operating screens when a destination name is selected in communications of the facsimile apparatus with a destination apparatus. The operating screen displaying unit 35 changes the operating screen on the touch panel 43.

First, the operating screen displaying unit 35 displays an operating screen read from the system memory unit 282 (S1).

Next, when a user selects a destination name having a communication type whose destination information is determined not to be displayed (YES in S13), the operating screen displaying unit 35 does not display the destination information. In this case, when “FAX TOKYO” (destination name “TOKYO” having a communication type “FAX”) is selected on the operating screen, it is determined whether destination information of the selected destination name is not to be displayed (S2). When it is determined that destination information of the selected destination name is not to be displayed (YES in S2), that is, when non-display of destination information is ON (not displayed), the operating screen displaying unit 35 does not display the destination information of “FAX TOKYO” on the operating screen in the touch panel 43 (S3). In this case, when the destination information of “FAX TOKYO” is determined not to be displayed, “FAX NUMBER” (destination information) of “FAX TOKYO” (Tokyo Headquarters) is not displayed.

When it is determined that destination information of the selected destination name is to be displayed (NO in S2), the operating screen displaying unit 35 displays the destination information of “FAX TOKYO” on the operating screen in the touch panel 43 (S4). That is, “FAX NUMBER” (destination information) of “FAX TOKYO” (Tokyo Headquarters) is displayed.

With this, it can be determined whether the destination information of the destination name is to be displayed on the operating screen in the touch panel 43.

When the destination information is displayed on the touch panel 43 together with the destination name by the operating screen displaying unit 35, the user confirms the destination information and communicates with the destination. When the destination information corresponding to the destination name is not displayed on the touch panel 43 by the operating screen displaying unit 35, the user communicates with the destination by only confirming the destination name.

[Second Operations of Facsimile Apparatus]

Next, referring to the drawings, second operations of the facsimile apparatus according to the embodiment of the present invention are described.

In the second operations of the facsimile apparatus according to the embodiment of the present invention, in order to prevent the destination information from being leaked, when the facsimile apparatus communicates with a destination apparatus, it is determined that the destination information is not to be displayed for each user of the facsimile apparatus.

Determination whether the destination information is to be displayed on the touch panel 43 is executed on an operating screen in the touch panel 43 displayed by the operating screen displaying unit 35. The destination information non-display determining unit 32 stores the determination whether the destination information is to be displayed on the touch panel 43 in the non-volatile memory unit 283 for each user of the facsimile apparatus.

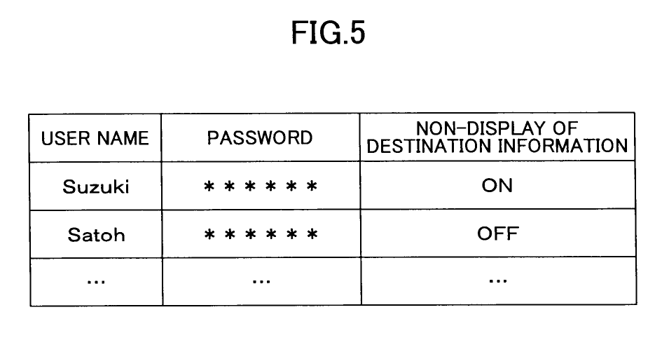

FIG. 5 is a user information management table in which non-display of destination information on the touch panel 43 is determined for each user. In the embodiment of the present invention, each user is identified by a password determined for that user. The password is input on the touch panel 43, and the password registering unit 37 registers the password in the non-volatile memory unit 283. In FIG. 5, as an example, it is determined that destination information is not to be displayed (ON) for a user name “Suzuki” and destination information is to be displayed (OFF) for a user name “Satoh”; then this determination is stored in the non-volatile memory unit 283.

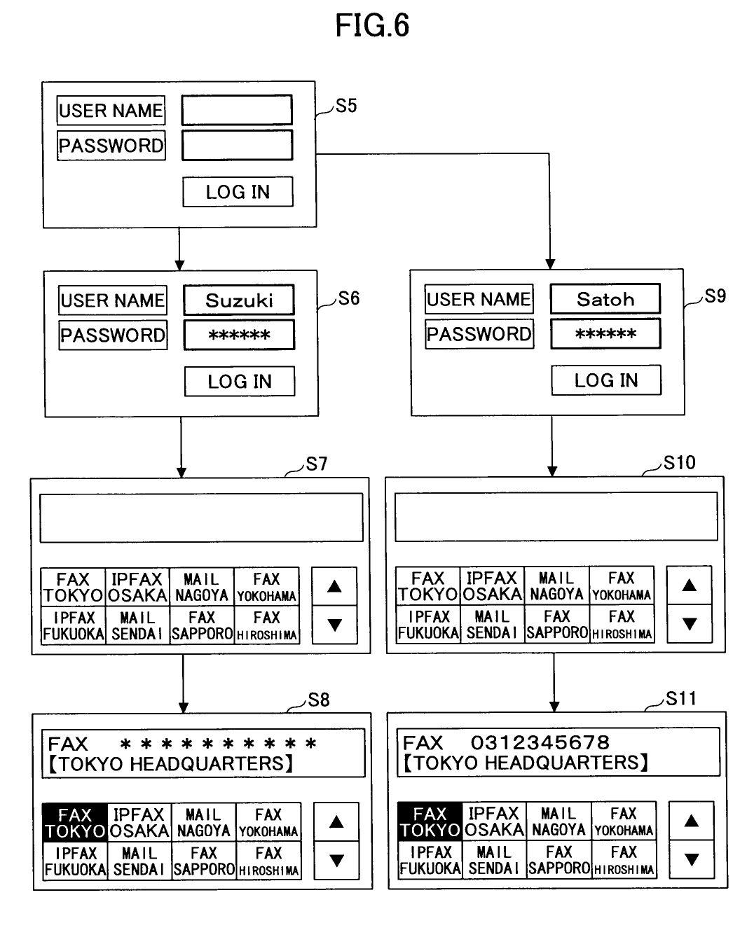

When a user operates the facsimile apparatus, the user selects a destination name on an operating screen in the touch panel 43 displayed by the operating screen displaying unit 35, and confirms destination information corresponding the selected destination name. FIG. 6 is a diagram showing a second flow of operating screens which are displayed by the operating screen displaying unit 35 when a user operates the facsimile apparatus.

First, the operating screen displaying unit 35 reads an operating screen from the system memory unit 282 and displays the operating screen on the touch panel 43 (S5). Next, the user inputs the user name “Suzuki” and his/her password on the touch panel 43 by using the password inputting unit 38 (S6). The authentication unit 36 authenticates whether the input password is equal to a password which has been registered by the password registering unit 37. When the input password is equal to the registered password, the user name “Suzuki” is logged into the facsimile apparatus. Then the operating screen displaying unit 35 reads an operating screen from the system memory 282 and displays the operating screen (S7).

Since the destination information non-display determining unit 32 has determined that the destination information is not to be displayed for the user name “Suzuki”, the operating screen displaying unit 35 does not display the destination information of “FAX TOKYO” on the operating screen in the touch panel 43 (S8). That is, “FAX NUMBER” (destination information) of “FAX TOKYO” (Tokyo Headquarters) is not displayed (S8).

When the user inputs the user name “Satoh” and his/her password on the touch panel 43 by using the password inputting unit 38 (S9), the authentication unit 36 authenticates whether the input password is equal to a password which has been registered by the password registering unit 37. When the input password is equal to the registered password, the user name “Satoh” is logged into the facsimile apparatus. Then the operating screen displaying unit 35 reads an operating screen from the system memory 282 and displays the operating screen (S10).

Since the destination information non-display determining unit 32 has not determined that the destination information is not to be displayed for the user name “Satoh”, the operating screen displaying unit 35 displays the destination information of “FAX TOKYO” on the operating screen in the touch panel 43 (S11). That is, “FAX NUMBER” (destination information) of “FAX TOKYO” (Tokyo Headquarters) is displayed (S11).

As described above, since non-display or display of the destination information can be determined for each user, the destination information can be prevented from being leaked and the destination information can be suitably managed.

When the destination information is displayed on the touch panel 43 together with the destination name by the operating screen displaying unit 35, the user confirms the destination information and communicates with the destination. When the destination information corresponding to the destination name is not displayed on the touch panel 43 by the operating screen displaying unit 35, the user communicates with the destination by only confirming the destination name.

[Third Operations of Facsimile Apparatus]

Next, referring to the drawings, third operations of the facsimile apparatus according to the embodiment of the present invention are described.

In the third operations of the facsimile apparatus according to the embodiment of the present invention, in order to prevent the destination information from being leaked, when the facsimile apparatus communicates with a destination apparatus, it is determined that the destination information is not to be displayed for each destination name.

Determination whether the destination information is to be displayed on the touch panel 43 is executed on an operating screen in the touch panel 43 displayed by the operating screen displaying unit 35. The destination information non-display determining unit 32 stores the determination whether the destination information is to be displayed on the touch panel 43 in the non-volatile memory unit 283 in each destination name.

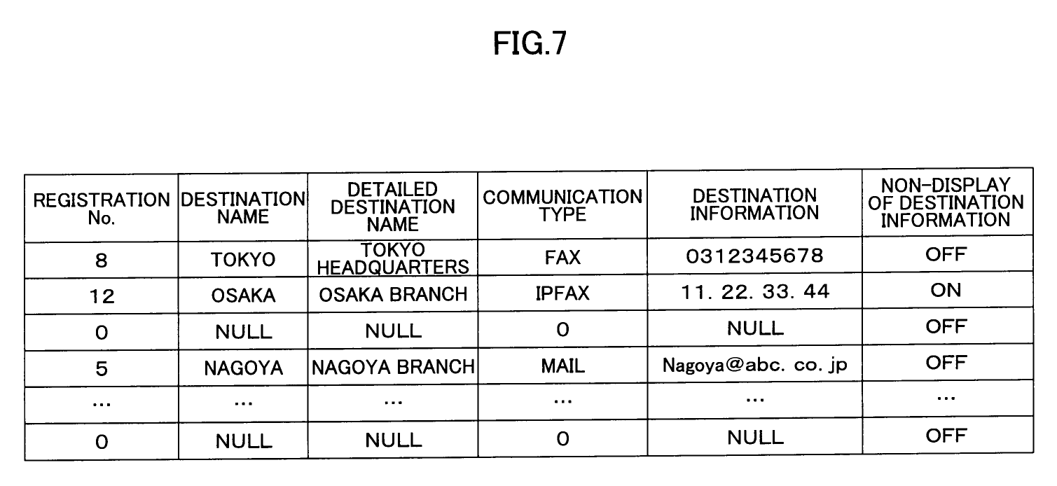

FIG. 7 is an address book table in which non-display of destination information on the touch panel 43 is determined for each destination name. In FIG. 7, as an example, the destination information non-display determining unit 32 determines that the destination information of “OSAKA” is not to be displayed and this determination is stored in the non-volatile memory unit 283.

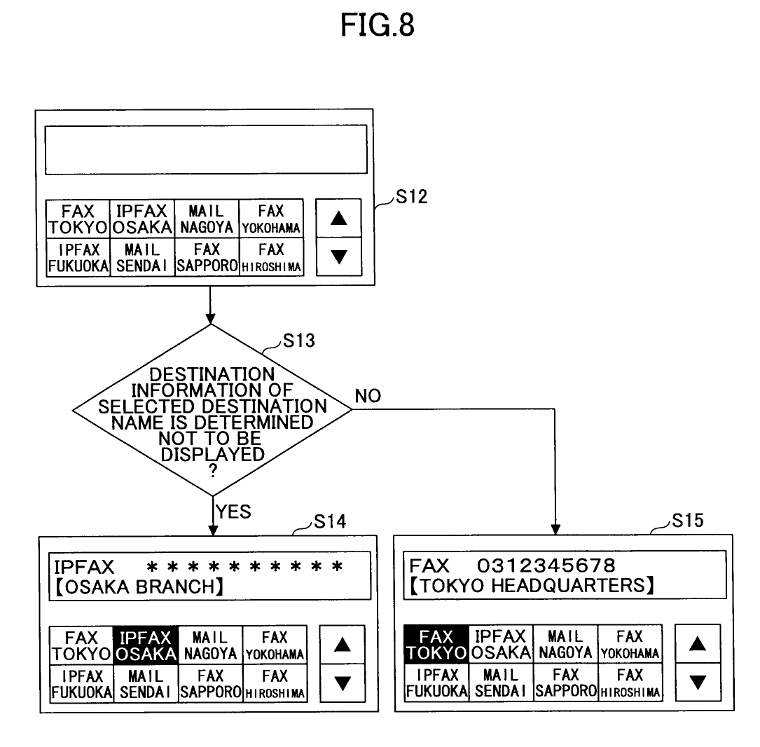

When a user operates the facsimile apparatus, the user selects a destination name on an operating screen in the touch panel 43 displayed by the operating screen displaying unit 35, and confirms destination information corresponding the selected destination name. FIG. 8 is a diagram showing a third flow of operating screens which are displayed by the operating screen displaying unit 35 when a user operates the facsimile apparatus.

First, the operating screen displaying unit 35 reads an operating screen from the system memory unit 282 and displays the operating screen on the touch panel 43 (S12).

Next, it is determined whether destination information of the selected destination name is not to be displayed by the destination information non-display determining unit 32 (S13).

When it is determined that destination information of the selected destination name is not to be displayed (YES in S13), the operating screen displaying unit 35 does not display the destination information of the destination name on the operating screen in the touch panel 43 (S14). That is, as shown in FIG. 7, since the destination information of “OSAKA” (destination name) is not to be displayed, “IPFAX NUMBER” (destination information) of “OSAKA” (destination name) is not displayed.

When it is determined that destination information of the selected destination name is to be displayed (NO in S13), the operating screen displaying unit 35 displays the destination information of the destination name on the operating screen in the touch panel 43 (S15). That is, when destination name “FAX TOKYO” is selected, since it is determined that the destination information of the selected destination name “FAX TOKYO” is to be displayed, “FAX NUMBER” (destination information) of “TOKYO HEADQUARTERS” (detailed destination name) is displayed (S15).

As described above, since non-display or display of the destination information can be determined for each destination name, the destination information can be prevented from being leaked and the destination information can be suitably managed.

When the destination information is displayed on the touch panel 43 together with the destination name by the operating screen displaying unit 35, the user confirms the destination information and communicates with the destination. When the destination information corresponding to the destination name is not displayed on the touch panel 43 by the operating screen displaying unit 35, the user communicates with the destination by only confirming the destination name.

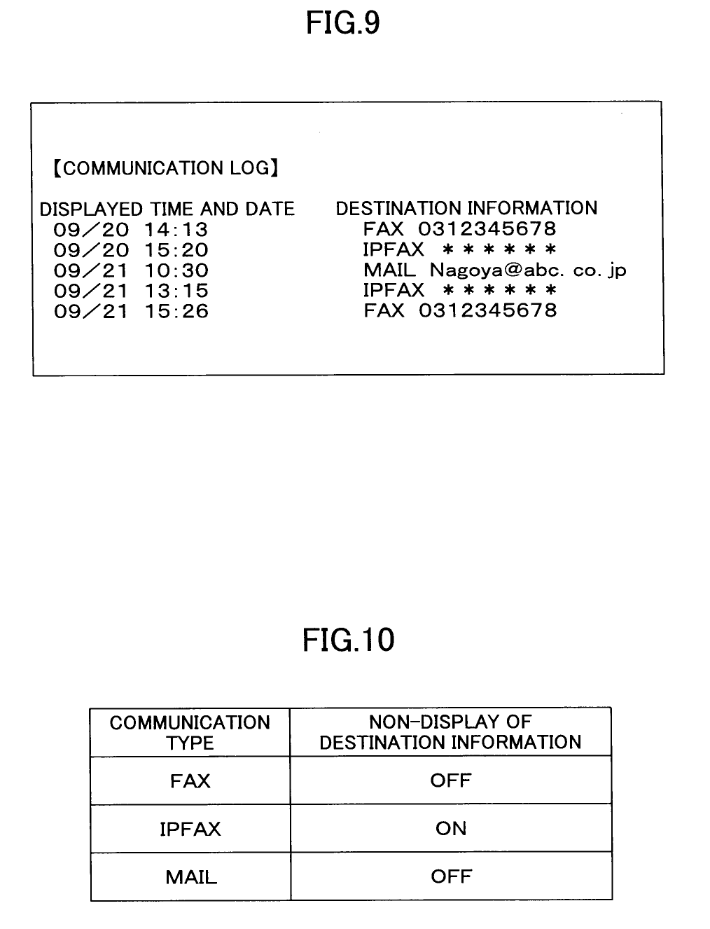

FIG. 9 is a diagram showing a communication log in the facsimile apparatus according the embodiment of the present invention. In the third operations of the facsimile apparatus, since it is determined that “IPFAX NUMBER” of “OSAKA” is not to be displayed, as shown in FIG. 9, the IPFAX number is not recorded in the communication log. With this, destination information is prevented from being leaked from the communication log.

[Fourth Operations of Facsimile Apparatus]

Next, referring to the drawings, fourth operations of the facsimile apparatus according to the embodiment of the present invention are described.

In the fourth operations of the facsimile apparatus according to the embodiment of the present invention, in order to prevent the destination information from being leaked, when the facsimile apparatus communicates with a destination apparatus, it is determined that the destination information is not displayed in each communication type. The communication types are, for example, facsimile “FAX”, IP facsimile “IPFAX”, or e-mail “MAIL”.

Determination whether the destination information is to be displayed on the touch panel 43 is executed on an operating screen in the touch panel 43 displayed by the operating screen displaying unit 35. The destination information non-display determining unit 32 stores the determination whether the destination information is to be displayed on the touch panel 43 in the non-volatile memory unit 283 in each communication type.

FIG. 10 is an information management table in which non-display of destination information on the touch panel 43 is determined for each communication type. As shown in FIG. 10, three communication types “FAX”, “IPFAX”, and “MAIL” are shown as the communication types. In FIG. 10, as an example, the destination information non-display determining unit 32 determines that the destination information of “IPFAX” is not to be displayed and this determination is stored in the non-volatile memory unit 283.

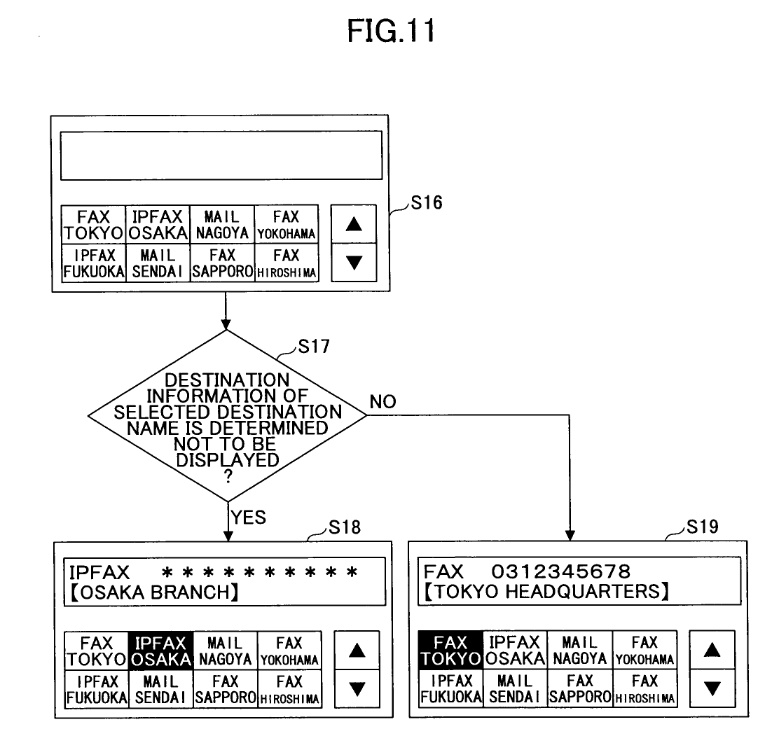

When a user operates the facsimile apparatus, the user selects a destination name on an operating screen in the touch panel 43 displayed by the operating screen displaying unit 35, and confirms destination information corresponding the selected destination name. FIG. 11 is a diagram showing a fourth flow of operating screens which are displayed by the operating screen displaying unit 35 when a user operates the facsimile apparatus.

First, the operating screen displaying unit 35 reads an operating screen from the system memory unit 282 and displays the operating screen on the touch panel 43 (S16).

Next, it is determined whether destination information of the selected destination name is not to be displayed by the destination information non-display determining unit 32 (S17).

When it is determined that destination information of the selected destination name is not to be displayed (YES in S17), the operating screen displaying unit 35 does not display the destination information of the destination name on the operating screen in the touch panel 43 (S18). That is, since it is determined that the destination information of the communication type “IPFAX” is not to be displayed, “IPFAX NUMBER” (destination information) of “OSAKA BRANCH” (detailed destination name) is not displayed.

When it is determined that destination information of the selected destination name is to be displayed (NO in S17), the operating screen displaying unit 35 displays the destination information of the destination name on the operating screen in the touch panel 43 (S19). That is, when destination name “FAX TOKYO” is selected, since it is determined that the destination information of the communication type “FAX” is to be displayed, “FAX NUMBER” (destination information) of “TOKYO HEADQUARTERS” (detailed destination name) is displayed (S19).

As described above, since non-display or display of the destination information can be determined for each communication type, the destination information can be prevented from being leaked and the destination information can be suitably managed.

When the destination information is displayed on the touch panel 43 together with the destination name by the operating screen displaying unit 35, the user confirms the destination information and communicates with the destination. When the destination information corresponding to the destination name is not displayed on the touch panel 43 by the operating screen displaying unit 35, the user communicates with the destination by only confirming the destination name.

[Fifth Operations of Facsimile Apparatus]

Next, referring to the drawings, fifth operations of the facsimile apparatus according to the embodiment of the present invention are described.

In the fifth operations of the facsimile apparatus according to the embodiment of the present invention, in order to prevent the destination information from being leaked, when the facsimile apparatus communicates with a destination apparatus, it is determined that the destination information is not to be displayed by combining a user name with a destination name.

Determination whether the destination information is to be displayed on the touch panel 43 is executed on an operating screen in the touch panel 43 displayed by the operating screen displaying unit 35. The destination information non-display determining unit 32 stores the determination whether the destination information is to be displayed on the touch panel 43 in the non-volatile memory unit 283 by combining a user name with a destination name.

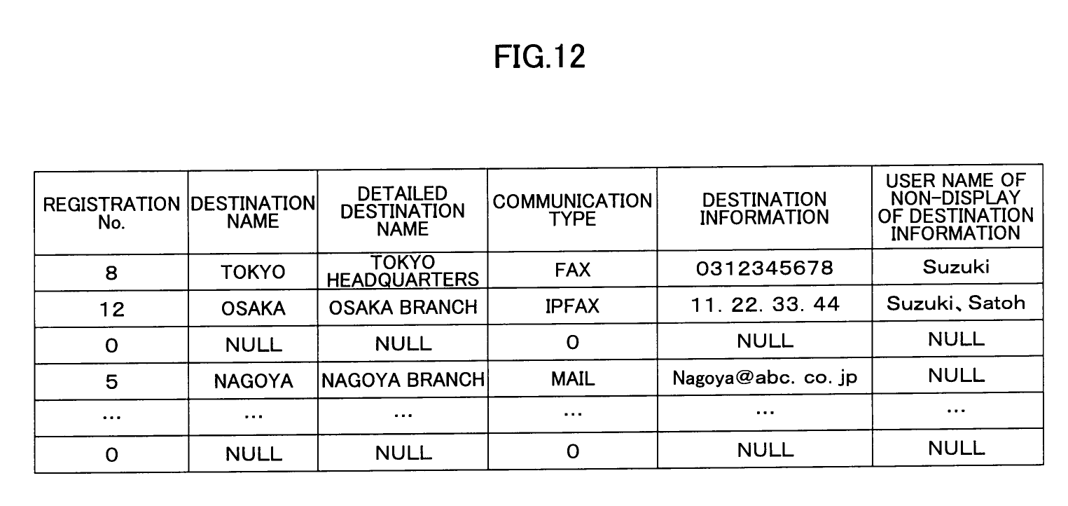

FIG. 12 is an address book table in which non-display of destination information on the touch panel 43 is determined by combining a user name with a destination name. In FIG. 10, as an example, the destination information non-display determining unit 32 determines that the destination information is not to be displayed under the name of “Suzuki” in the destination name “TOKYO” and the destination information is not to be displayed under the names of “Suzuki, Satoh” in the destination name “OSAKA”. This determination is stored in the non-volatile memory unit 283.

When a user operates the facsimile apparatus, the user selects a destination name on an operating screen in the touch panel 43 displayed by the operating screen displaying unit 35, and confirms destination information corresponding the selected destination name.

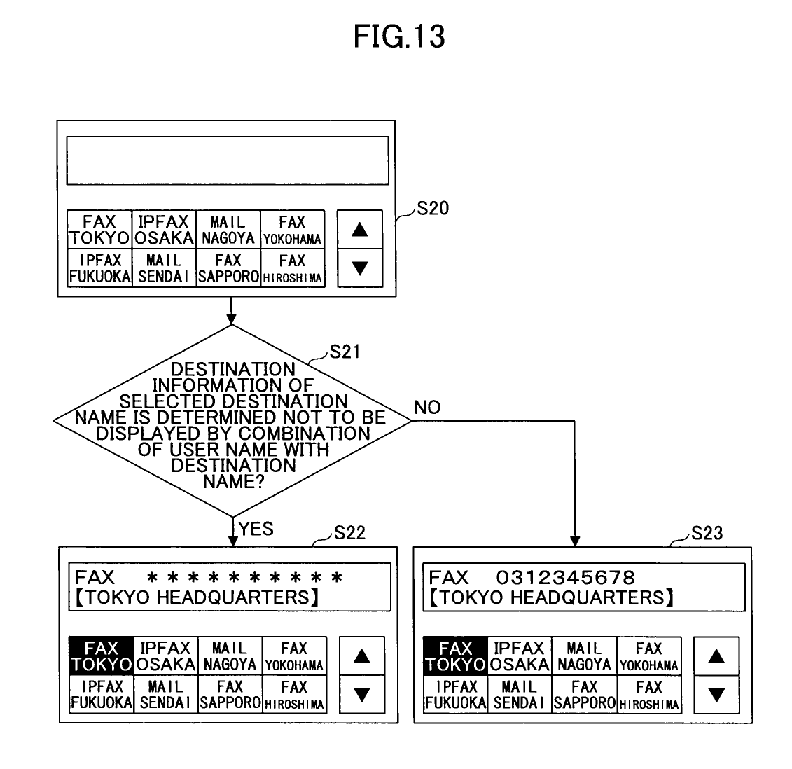

FIG. 13 is a diagram showing a fifth flow of operating screens which are displayed by the operating screen displaying unit 35 when a user operates the facsimile apparatus.

First, the operating screen displaying unit 35 reads an operating screen from the system memory unit 282 and displays the operating screen on the touch panel 43 (S20).

Next, it is determined whether destination information of the selected destination name is not to be displayed by a combination of a user name with the destination name by the destination information non-display determining unit 32 (S21).

When it is determined that destination information of the selected destination name is not to be displayed by a combination of a user name with a destination name (YES in S21), the operating screen displaying unit 35 does not display the destination information of the destination name on the operating screen in the touch panel 43 (S22). That is, since it is determined that the destination information of the destination name “TOKYO” is not to be displayed by combining the user name “Suzuki”, “FAX NUMBER” (destination information) of “TOKYO” (destination name) is not to be displayed by the combination of the detailed destination name “TOKYO HEADQUATERS” with the user name “Suzuki”.

When it is determined that destination information of the selected destination name is to be displayed by a combination of a user name with a destination name (NO in S21), the operating screen displaying unit 35 displays the destination information of the destination name on the operating screen in the touch panel 43 (S23). That is, since it is determined that the destination information of the destination name “TOKYO” is to be displayed by combining the user name “Satoh” (not shown), “FAX NUMBER” (destination information) of “TOKYO HEADQUARTERS” (detailed destination name) is displayed by the combination of the destination name “TOKYO HEADQUARTERS” with the user name “Satoh”.

As described above, since non-display or display of the destination information can be determined by a combination of a user name with a destination name, the destination information can be prevented from being leaked and the destination information can be suitably managed.

When the destination information is displayed on the touch panel 43 together with the destination name by the operating screen displaying unit 35, the user confirms the destination information and communicates with the destination. When the destination information corresponding to the destination name is not displayed on the touch panel 43 by the operating screen displaying unit 35, the user communicates with the destination by only confirming the destination name.

[Sixth Operations of Facsimile Apparatus]

Next, referring to the drawings, sixth operations of the facsimile apparatus according to the embodiment of the present invention are described.

In the sixth operations of the facsimile apparatus according to the embodiment of the present invention, even if the destination information non-display determining unit 32 determines that destination information is not to be displayed and the destination information is not displayed on the touch panel 43, the operating screen displaying unit 35 displays the destination information on the touch panel 43 by authenticating a password of a user.

When a user operates the facsimile apparatus, the user selects a destination name on an operating screen in the touch panel 43 displayed by the operating screen displaying unit 35, and confirms destination information corresponding the selected destination name.

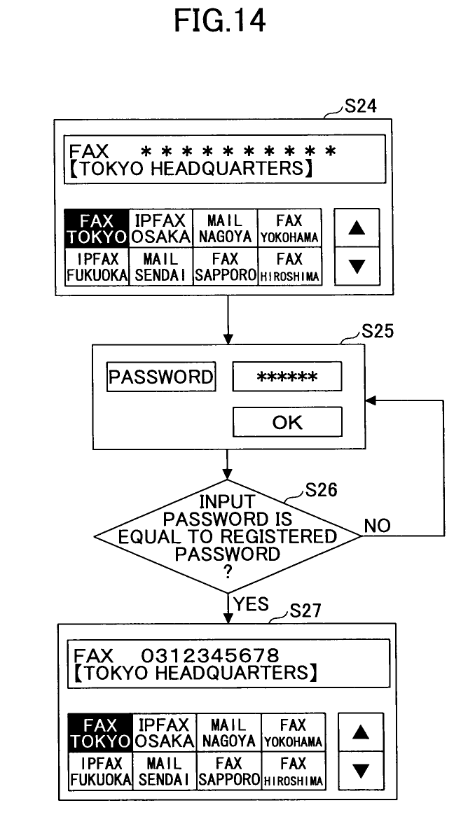

FIG. 14 is a diagram showing a sixth flow of operating screens which are displayed by the operating screen displaying unit 35 when a user operates the facsimile apparatus.

First, the operating screen displaying unit 35 does not display destination information (facsimile number; FAX NUMBER) of a destination name “FAX TOKYO” based on the determination by the destination information non-display determining unit 32 (S24).

Next, the operating screen displaying unit 35 reads an operating screen on which a password is to be input from the system memory unit 282 and displays the operating screen on the touch panel 43 (S25). When a password is input by using the password inputting unit 38, the authentication unit 36 authenticates whether the input password is equal to a password registered by the password registering unit 37 (S26).

When the authentication unit 36 authenticates that the input password is equal to a password registered by the password registering unit 37 (YES in S26), the operating screen displaying unit 35 displays the detailed destination name “TOKYO HEADQUATERS” on the touch panel 43 together with the destination information “FAX NUMBER”.

When the authentication unit 36 does not authenticate that the input password is equal to a password registered by the password registering unit 37 (No in S26), the operating screen displaying unit 35 displays again the operating screen on which a password is to be input (S25).

When the password is suitably managed, the destination information can be prevented from being leaked.

After authenticating the password, when the destination information is displayed on the touch panel 43 together with the destination name by the operating screen displaying unit 35, the user confirms the destination information and communicates with the destination apparatus.

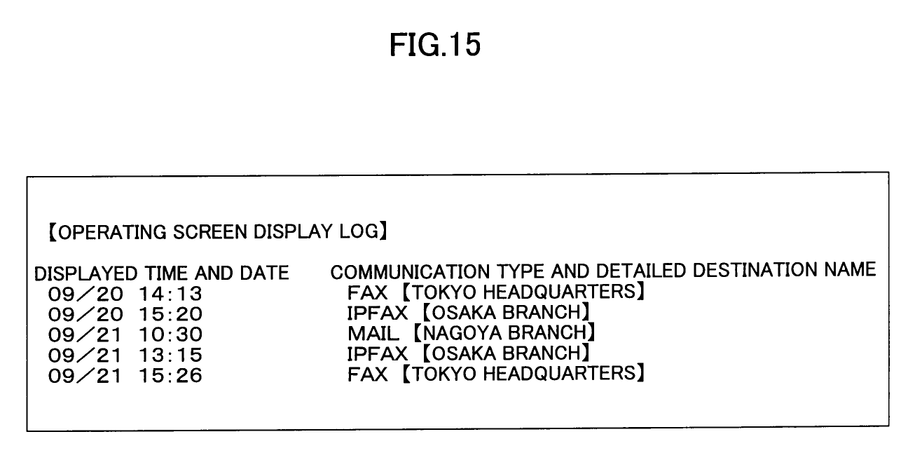

FIG. 15 is a diagram showing an operating screen display log in the facsimile apparatus according the embodiment of the present invention. In the sixth operations of the facsimile apparatus, when facsimile transmission is executed by password authentication, as shown in FIG. 15, an operating screen display log is recorded. Therefore, when destination information is leaked, the destination information can be traced using the operating screen display log.

Further, the present invention is not limited to the specifically disclosed embodiment, and variations and modifications may be made without departing from the scope of the present invention.

The present invention is based on Japanese Priority Patent Application No. 2007-262267, filed on Oct. 5, 2007, with the Japanese Patent Office, the entire contents of which are hereby incorporated herein by reference.

What is claimed is:

1. A communication apparatus, comprising:
a destination information storing unit which stores a destination name and destination information corresponding to the destination name;
an operating screen displaying unit which displays information of operations of the communication apparatus; and
a destination information non-display determining unit which determines whether the destination information is not to be displayed on the operating screen; wherein
when a destination name stored in the destination information storing unit is displayed and the destination name is selected as a destination, the operating screen displaying unit displays the destination information together with the destination name on the operating screen; and
when the destination information non-display determining unit determines that the destination information is not to be displayed on the operating screen, the destination information non-display determining unit does not display the destination information on the operating screen.

2. The communication apparatus as claimed in claim 1, wherein:
the destination information non-display determining unit determines not to display the destination information for each user of the communication apparatus.

3. The communication apparatus as claimed in claim 1, wherein:
the destination information non-display determining unit determines not to display the destination information for each destination name of the communication apparatus.

4. The communication apparatus as claimed in claim 1, wherein:
the destination information non-display determining unit determines not to display the destination information for each communication type of the destination.

5. The communication apparatus as claimed in claim 1, wherein:
the destination information non-display determining unit determines not to display the destination information for a combination of the user with the destination name.

6. The communication apparatus as claimed in claim 1, further comprising:
a password registering unit which registers a password of a user in a memory unit beforehand; and
a password inputting unit which causes a user to input his/her password when the user operates the communication apparatus; wherein
when a password input by the password inputting unit is equal to a password registered by the password registering unit, the operating screen displaying unit displays the destination information together with the destination name.

7. The communication apparatus as claimed in claim 6, further comprising:
an operating screen displayed log recording unit which records a displayed time and date of the destination information on the operating screen together with the destination name when the password input by the password inputting unit is equal to the password registered by the password registering unit.

8. The communication apparatus as claimed in claim 1, further comprising:
a communication log recording unit which records a communication time and date of the communication apparatus with a destination apparatus and the destination information displayed by the operating screen displaying unit.

9. The communication apparatus as claimed in claim 2, further comprising:
a communication log recording unit which records a communication time and date of the communication apparatus with a destination apparatus and the destination information displayed by the operating screen displaying unit.

10. The communication apparatus as claimed in claim 3, further comprising:
a communication log recording unit which records a communication time and date of the communication apparatus with a destination apparatus and the destination information displayed by the operating screen displaying unit.

11. The communication apparatus as claimed in claim 4, further comprising:
a communication log recording unit which records a communication time and date of the communication apparatus with a destination apparatus and the destination information displayed by the operating screen displaying unit.

12. The communication apparatus as claimed in claim 5, further comprising:
a communication log recording unit which records a communication time and date of the communication apparatus with a destination apparatus and the destination information displayed by the operating screen displaying unit.
